(19) United States
(12) Patent Application Publication
(10) Pub. No.: US 2013/0185357 A1
(43) Pub. Date: Jul. 18, 2013

(54) Method for Advertising and Marketing Goods and Services Using an Online Lifestyle Shopping Center

(71) Applicants: Jeffrey E. Goss, Asheville, NC (US); John W. Bell, III, Asheville, NC (US)

(72) Inventors: Jeffrey E. Goss, Asheville, NC (US); John W. Bell, III, Asheville, NC (US)

(21) Appl. No.: 13/741,038

(22) Filed: Jan. 14, 2013

Related U.S. Application Data
(60) Provisional application No. 61/586,388, filed on Jan. 13, 2012.

(51) Int. Cl. H04L 29/08

(52) U.S. Cl. CPC H04L 67/22
USPC 709/204

(57) ABSTRACT

A social networking system electronically assimilates a database of social networking system (SNS) member profiles and associated brand websites on a server connected by a data communications network to a plurality of remote computers. The system utilizes a respective psychographic profile to establish a lifestyle center website on the social networking system server, and the lifestyle center website includes a first set of digital content data related to the psychographic profile. The lifestyle center website displays an anchor tenant website hosted on the SNS server and having a second set of digital content data related to the psychographic profile. The system further identifies social networking system member profiles that match the identified psychographic profile for the lifestyle center website. The system allows SNS members and brand owners to connect within the social networking system for a more efficient online shopping experience.

### CROSS REFERENCE TO RELATED APPLICATIONS

This application claims priority to and incorporates by reference herein U.S. Provisional Patent Application Ser. No. 61/586,388 filed on Jan. 13, 2012.

### BACKGROUND

Current online shopping options are “all products to all people,” or in other cases, an attempt is made to track one's clicks and purchases to make recommendations for products and brands. It has become increasingly clear that as active as the internet, social networks, and online shopping are, it is costly and difficult to target specific consumer profiles online in large numbers in a cost effective manner. Advertisers are limited to natural search engine optimization (SEO), expensive, general targeted display advertising such as that found on portals, broad general population websites (e.g., weather channel sites, travel sites, newspapers, etc.), natural viral social marketing, and fading “keyword search/pay per click.”

Efforts to provide convenient shopping for goods and services to a certain kind of consumer are not available online. There is a need to develop the same online to meet online shopping demand more effectively. Methods of tracking purchasing habits at a particular store include implementing “segmentation analysis” that identifies a brand's customer personality profile, lifestyle traits and media habits by filtering certain zip codes from national credit card data. Segmentation analysis dates back to 1951 when the first credit cards were issued. There are several companies which, by providing at least 3000 zip codes of a brand's customers, can conduct the exercise and can provide the data and results of a psychographic profile of a brand's customer.

While online shopping is currently growing at twenty-seven percent annually and more than sixty-five percent of U.S. adults use social media, no effective tool exists for assimilating groups of brands that appeal to a certain segment of the population and that provides the infinite benefits and possibilities for brands to market and build relationships with their customers for a more efficient online shopping experience.

Today's renowned social networks such as Facebook® connect people through geographic location searches, demographics, and broad general commonalities, such as high school, college, work, family, church, associations and encounters etc., but not by lifestyle, hobby, interest, or activity. While some individuals within a Facebook® friend network may have hobbies and interests in common because the group of friends is founded on broad, general commonalities, the percentage cannot be aggregated effectively and therefore is neither marketable nor meaningful to advertisers for particular brands. Accordingly, social network fans do not have means to meet people through lifestyle commonalities.

Aggregating purchasers with common shopping tastes and habits and directing them to a consolidated area for reviewing multiple brands that would appeal to the group as a whole is not currently available online. Amazon®'s “Users Like You . . . ” and

“Recommended Products,” Google®'s Plus Circles and Facebook®'s fan pages attempt to aggregate people through data mining that monitors a particular shopper's activity online Yet, Amazon® is limited by search and purchase histories and is blind to gift purchases, therefore skewing the results. The best an advertiser can do today to capitalize on the growing phenomenon of online shopping and social activity is to capture their target customer online through:
Rich natural website SEO;
Category display advertising (only drives approximately eighteen percent of online shopping); and
Social content the advertiser hopes will go viral.

Nothing exists online today that effectively connects online shoppers with a psychographically driven, permission-based social network in meaningful numbers to marketers and brands.

### BRIEF SUMMARY OF THE INVENTION

In one embodiment, a social networking system (SNS) is implemented over a computerized network connecting a multitude of remote computers. The social networking system includes at least one SNS server hosting at least one lifestyle center website displaying digital content data related to at least one anchor tenant website also hosted on said SNS server. At least one database is stored on the SNS server and tracks member profiles corresponding to SNS users with accounts on the social networking service. The SNS server includes a first non-transitory computer readable memory, and the memory incorporates computerized instructions programmed therein to connect a member profile with the lifestyle center website and granting the member profile access for bi-directional communication with the lifestyle center website. At least one remote computer operated by at least one SNS user has a member profile on the social networking service, and the remote computer includes a second non-transitory computer readable memory storing communications software programmed to transmit communications data from the remote computer to the SNS server and to communicate with the lifestyle center website on the SNS server.

In a different embodiment, a computerized method implements a social networking system (SNS) that electronically assimilates a database of social networking system (SNS) member profiles and associated brand websites on a social networking system (SNS) server connected by a data communications network to a plurality of remote computers. The method includes (i) identifying a respective psychographic profile to establish a lifestyle center website on the social networking system (SNS) server, wherein the lifestyle center website includes a first set of digital content data related to the psychographic profile; (ii) displaying an anchor tenant website hosted on the SNS server and having a second set of digital content data related to the psychographic profile; (iii) identifying social networking system member profiles that match the identified psychographic profile for the lifestyle center website; and (iv) connecting within the social networking system the matching member profiles and the lifestyle center website.

### BRIEF DESCRIPTION OF THE FIGURES

FIG. 1 is a webpage schematic illustration of one layout of an online lifestyle center website according to this disclosure.

FIG. 2 is a flowchart illustrating the method of establishing the social networking service described herein.

### DETAILED DESCRIPTION OF THE INVENTION

By identifying the psychographic profile, one may identify multiple brands for an “online lifestyle center” to reach their customers and prospects at little or no cost.

The online lifestyle center builds a social network of brands which share the same customers and a network of customers who share the same lifestyle. Brands are not only welcome, they are sought.

For each “online lifestyle center” execution or “cluster,” a website is created by identifying a brand that strongly represents one of sixty-six known psychographic profiles nationally. The online lifestyle center website utilizes this “anchor tenant's” database to detail and verify the psychographic profile of customers shopping with the “anchor tenant” and to identify a group of brands, for example forty to one hundred brands, that serve a particular consumer profile in various categories based on lifestyle, and, therefore, provide potential customers within this consumer profile with access to dozens of their most likely favorite brands. These brands provide the products and services serving the consumers’ needs in their lifestyle categories all together in one place, on one website. Each of the brands displays special offers within the online lifestyle center websote and offers exclusive deals, such as nationally recognized coupons, to customers who encounter the brand through the online lifestyle center website. The online lifestyle center website, therefore, becomes the single source for a group of customers' most intimate, complete and insightful information on a particular brand, including private product launches and reviews, which may be exclusive to the online lifestyle center members. Within an online lifestyle center's website, a consumer may customize the way that certain brands are displayed on the page and to exhibit a selection of brands that fit that customer even more personally.

In a social networking system described herein, consumers are able to join or create social groups within the online lifestyle center website where the customer will meet and get to know people around the world that share the same passion for a specific lifestyle, activity or interest. Without the consolidation of brands around an online lifestyle center as described herein, these disparate shoppers would otherwise most likely never have met. Within these social groups relating to activities surrounding the brands, the consumers can learn and share their opinions, experiences, thoughts, reviews of products, and information through chat, Skype, video and photos, all available through the social networking system described herein. They will be able to meet new friends through the social groups or contact an existing friend on the online lifestyle center website or other social networks and go “virtual shopping” into the brand partners' pages. Brand owners may initiate group activities within the online lifestyle center with a product review or perhaps by an industry expert/influencer/celebrity making appearances within the groups that have gathered through online activity surrounding the online lifestyle center. The brand owners may also utilize the online lifestyle center website as a forum for providing expert opinions, posting instruction demonstrations and sharing intimate experiences in activity relevant to the brand. The online lifestyle center website provides intimate relationships with the brands that fit the consumer's lifestyle and attract other people in the world who share the same passions.

For each online lifestyle center, the website will assemble compatible brands, for example up to one hundred brands, that provide products or services to a specific consumer personality profile nationally and provide exclusive values to visitors who examine the online lifestyle center website. In this way, the online lifestyle center provides an unprecedented online shopping experience and a social networking opportunity between individuals around the world participating in the activities, interest and lifestyle surrounding a common identified psychographic profile brand. This ultimately provides an unprecedented consumer targeting and consumer relationship building opportunity for brands.

The online lifestyle center website gives users a rich experience that has more to do with how they think and feel rather than what they click; meets the customers' important emotional needs by personal contact with brands and others who share the same interest and lifestyle; better focuses the brand's efforts on their consumer relationships and needs; enables customers to feel a part of the brand and become a brand loyalist; takes the strategies and successes of brick and mortar lifestyle centers online and applies the “specific things for a specific people” strategy by applying the “brands of a feather” concept to online shopping; makes shopping a more convenient and pleasurable experience by having associations with other brands that fill the consumer's needs; gives shoppers what they want most—a relationship, a great deal, valuable information to make an intelligent purchase choice to enjoy the activity or interest they have a passion for and that they bought the item for; and provides a social component to meet and share information with other brand loyalists and specific lifestyle enthusiasts.

The social networking system described herein may develop an online lifestyle center website for every nationally recognized psychographical profile using standard segmentation analysis marketing research tools. The online lifestyle center website hosts not only the anchor brand whose data defined the psychographic profile to which the online lifestyle center is directed, but the same online lifestyle center website incorporates links to additional tenants whose products and services fit the psychographic profile as well. The online lifestyle center website combines brand affinity, online shopping and social media for the ultimate online experience. Each participating business or brand also exposes its brand to the thousands of customers of other brands at little or no cost by trading exposure in already existing marketing materials, i.e., programs, newsletters, websites, brochures, in store, e-mail, social networks, ads, catalogs, etc.

To begin with, a brand is selected as the anchor tenant of each predetermined online lifestyle center website. Using the zip codes number a large group of customers, such as 3000 or more, of this anchor brand, psychographic profile analysis is conducted to identify the psychographic profile, lifestyle and purchasing behavior of the anchor tenant's customer. Alternatively, more than a single brand may be selected as the anchor tenants.

Applying a critical marketing research tool to the methodology, the anchor tenant's customer database is obtained (the more customers, the more effective). The zip codes will be matched to credit card purchase data registered since the inception of the credit card. From this data, the lifestyle, media, purchase behavior and psychographic profile group to which the consumer belongs is determined. This not only identifies what other products and services are used and purchased, but also when and how often, eventually allowing for relationship marketing based on desire and need. The Online Lifestyle Center website also provides for consumer to brand communications under each brand member page.

Once the anchor brand is determined and psychographic profile analysis is conducted, an additional number of compatible brands and retailers may also be linked to the online lifestyle center website. For example, each online lifestyle center may include dozen of brands that represent the various categories of a group of consumers' lifestyle, discovered during the profiling process to be considered for inclusion in the online lifestyle center website, as brands that best fulfill the specific lifestyle category with products or services.

Participating brands will provide exclusive, best offers and valued information that relates to the members of the online lifestyle center. These are offers and information beyond what exist in stores and elsewhere online

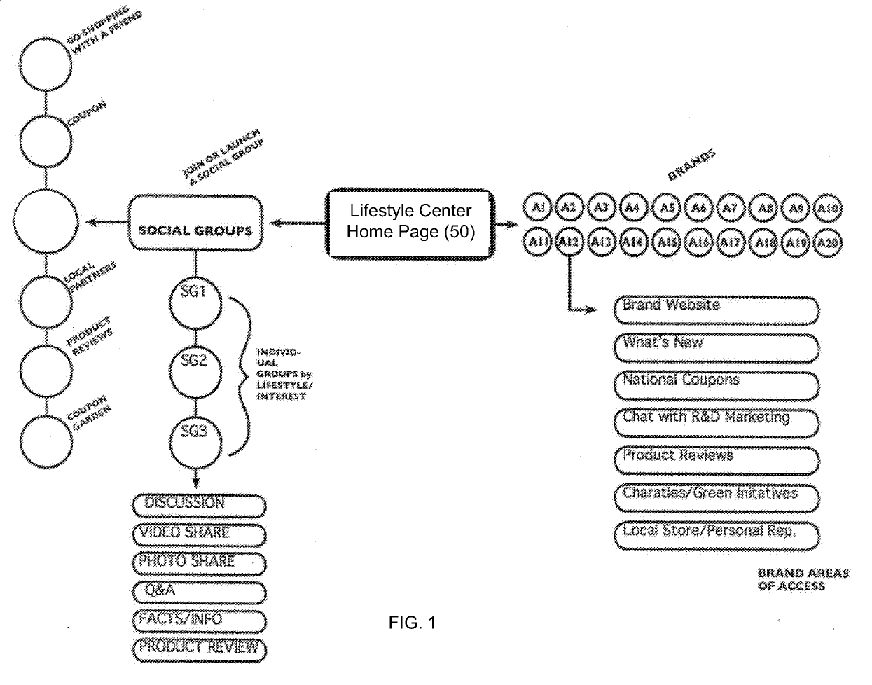

The attached FIG. 1 illustrates the online lifestyle center method discussed herein.

Consumers will be driven to the online lifestyle center website homepage through brand partner and consumer touch points, expediting ramp-up “to market” time, minimizing advertising costs and avoiding a funding or investing need. In-store salespersons' promotions, QR codes (approximately thirty-four percent of consumers currently use QR code technology from their smart phones today and QR capable phone sales are expected to reach $240B by 2014), catalogues, window decals, public relations, bags, receipts and advertising are also available to direct appropriate groups of consumers to an appropriate online lifestyle center website.

The brands identified on FIG. 1 are illustrated as A1-A100. When arriving on the online lifestyle center home page, consumers will be exposed to a webpage with dozens if not hundreds of logos representing brands that actually interest them based on their personal lifestyle, their “favorite brands” or potential “favorite brands.” The logo of the brand partner by which they entered or were introduced to the site, will be sufficiently highlighted to ensure the consumers are aware they are in the right place.

Once on the website, the consumers may click one of their favorite brand's logo, which will take them to the specific brand page where they are provided exclusive valuable offers as well as: What's New?; National Coupons; Chat with R&D Marketing (behind-the-scenes tour); Product Reviews; Charities/Green Initiatives; Local Store/Personal Representative Introduction; and Go Shopping with a Friend.

Members of the social networking system described herein will have the option to customize their experience on the online lifestyle center website by suggesting brands to this website.

FIG. 1 also depicts social groups labeled SG1, SG2 and SG3 affiliated with the website created by members, brand enthusiasts, or brands with illustrations of functions within social groups, e.g., discussion, video share, photo share, Q&A, facts/info, and product review.

Upon landing on a brand partner web page, social groups pertaining to the interest, lifestyle or hobby surrounding the brands in the online lifestyle center will appear on a portion of the screen, e.g., one third, for participation. Members may join an existing group or create a new, personal group by tossing out content, a question, a fact or comment. Brands may also “ignite” a social group by tossing out a product review, comment/question to the website visitors or orchestrate a celebrity online seminar, chat, demo and Q&A.

Further, visitors have the option to customize their page by suggesting brands to the website or choosing other brand options or substitutions from the “Brand Pool.”

The online lifestyle center website also has other direct features on the home page. Upon entering the homepage, visitors, especially frequent visitors, rather than going directly to the brand member pages, may click and go directly to the social network “groups,” or to one of other buttons on the home page as follows: (1) invite a friend in the lifestyle group or other social network to “Go Shopping” so they can shop together, review and discuss products in real-time by live chat and/or with video; (2) go directly to a coupon webpage where all coupons from all partner brands are immediately available in one place; (3) go directly to “Product Reviews and News;” (4) immediately log onto one of several real-time, active social groups which are formed around activities, lifestyles or interests related to the brand partner's products or use of products or members may start a social group which will be available to all members; (5) connect with brands' local stores with plug-ins; (6) connect with independent stores and restaurants, etc., by city, that appeal to the cluster personality profile; and (7) go to a map with all participating brands' locations.

The online lifestyle center website provides unprecedented benefits, marketing and customer relationship management opportunities for brands, such as cross-marketing via other brand partners connected to the online lifestyle center, immense brand exposure to potentially millions who fit their consumer profile, driven to their offer by compatible brands; develop data-rich customer profiles and relationships for “timing marketing,” offering products and sales when desired or needed; power networks of social groups pivoting around brand, lifestyles and product use; unprecedented, cost effective direct target marketing; and a store at a fraction of the cost of an on-the-ground store in a physical lifestyle center, e.g., real estate cost and risks, stocking, upfit/fixtures, personnel, training, taxes, timing to market. Consumers are driven to the online lifestyle center website by numerous brand partners in the online lifestyle center, and brands can host multiple social groups of consumers with an interest in the company's products and lifestyles surrounding them.

The visitor to the website has many benefits not available all in one place online today, such as: unprecedented deals and values from favorite brands stores; instant access to all their favorite brands in one place, instant access to all coupons, deals, offerings from favorite brands nationally; ability to connect with people worldwide who share their same interest, activities, and hobbies to share experiences, stories, facts and information; connect with an online lifestyle center friend to go shopping together online in real time; and a personal introduction to a brand's local store and sales team. The visitor has unprecedented access to his or her favorite brand's information, such as: sustainability efforts; cross marketing campaigns; national advertising campaigns/photos; forums with research and development and marketing to share ideas (behind-the-scenes tours); industry news and endorsements; and new product information, review and demonstrations.

The online lifestyle center website is hosted on a server which, in effect, is a powerful general purpose digital computer having substantial storage space. The server is always connected to the internet so that users may access the website from their own computers and handheld devices which are also connected to the internet.

The method described herein is transformative in that it uses readily available national credit card and zip code data to form an online lifestyle center website providing mutual benefits to buyers and sellers referred to herein.

In one embodiment, the social networking system disclosed herein uses an online lifestyle center website (50) as a hub for engaging a previously identified group of consumers who fit a psychographic profile. The lifestyle center website (50) is the center of activity, but owners of brands that would be interesting to particular consumers may utilize “space” on the lifestyle center website to promote their own brands. These other brand owners are referred herein as “tenants” within the lifestyle center website because they affiliate with the lifestyle center website and occupy digital space therein without owning or absolutely controlling the lifestyle center website itself “Tenants” are further described herein as “anchor tenants” which are usually large market drivers whose data has been used to establish the overall psychographic profile for the lifestyle center and “additional tenants” who may be smaller retailers or service providers that would be interesting to a particular psychographic profile. The words tenants, anchor tenants, and additional tenants are not limiting of the invention herein but are merely illustrative of the kinds of brand management that the lifestyle center website controls.

The social networking system (SNS) is implemented over a computerized network connecting a multitude of remote computers and includes at least one SNS server hosting at least one lifestyle center website (50) displaying digital content data related to at least one anchor tenant website also hosted on said SNS server. In this sense, the lifestyle center website, the anchor tenant website, and additional tenant websites may be “members” of the social networking system as well. At least one database is stored on the SNS server and tracks member profiles corresponding to SNS users with accounts on the social networking service. The SNS server has the appropriate hardware for online electronic communications, including a first non-transitory computer readable memory, and the memory has computerized instructions programmed therein to connect a member profile with the lifestyle center website (50) as well as other members within the social networking system. The server also has the capability to grant the member profile access for bi-directional communication with the lifestyle center website (50). At least one remote computer is operated by at least one SNS user having a member profile on the social networking service, wherein the remote computer comprises a second non-transitory computer readable memory storing communications software programmed to transmit communications data from the remote computer to the SNS server and to communicate with the lifestyle center website (50) on the SNS server. The remote computer of course encompasses all modern processing and data transmitting devices whether used in a hand held, laptop, or desktop manner. In this regard, the social networking service (SNS) server described herein has all of the functionality of most other social networks (e.g., ability to link to “friends,” the ability to communicate by messages and posts, the ability to organize data for shopping and the like. The lifestyle center website includes at least one computerized link allowing members of the social networking service to access additional digital content data related to at least one additional tenant having a tenant website hosted on said SNS server and in electronic communication with said lifestyle center website. As noted above, the online lifestyle center website is directed to compile brand information and corresponding vendor websites in on place such that a particular target group of consumers fitting a particular psychographic profile have access to multiple brands that fit their profile. This consolidation allows for members of the social networking system to connect within the social networking system via the lifestyle center website.

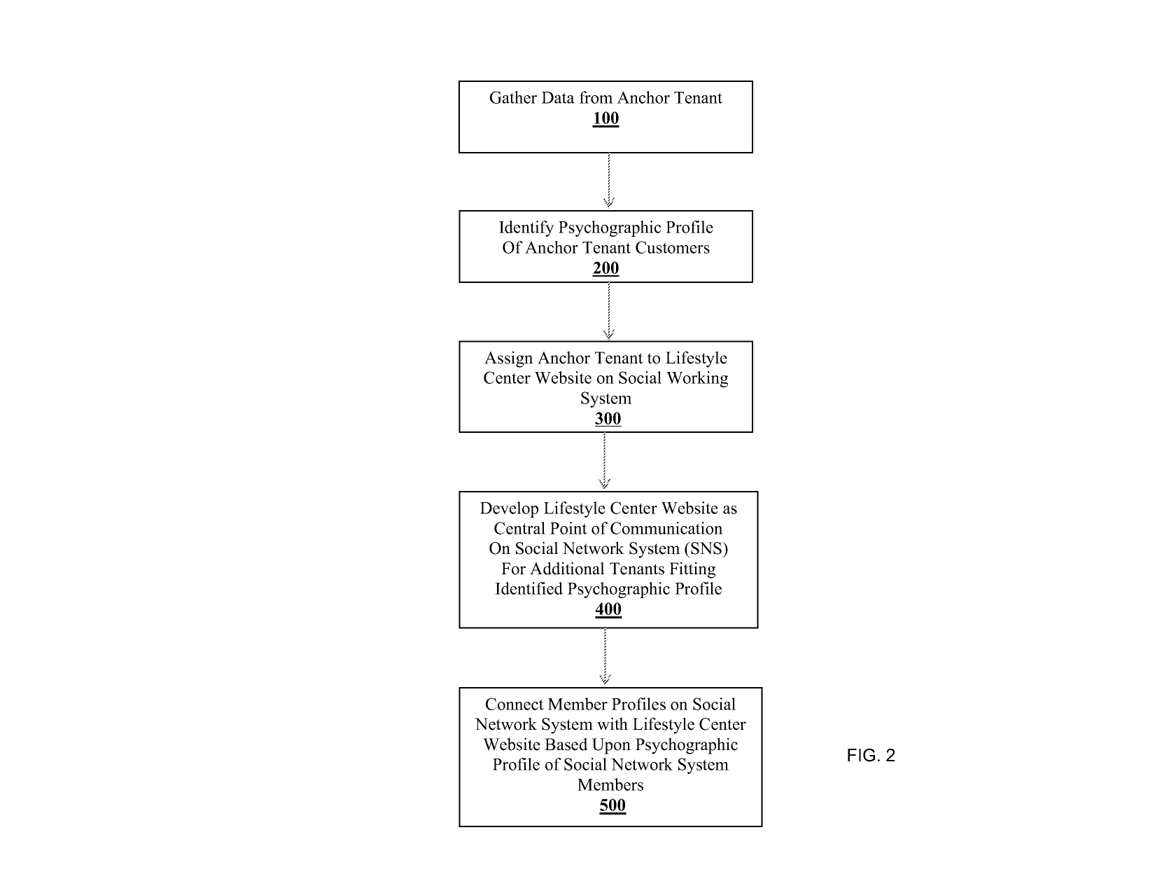

The social networking system described above is implemented via a computerized method shown in FIG. 2. At step (100), data from an anchor tenant for the online lifestyle center (50) is gathered (e.g., credit card data, zip code data, and purchasing data) and a demographic or more particularly a psychographic profile is established (200) for customers using that anchor tenant. The psychographic profile describes the consumers according to lifestyles, tastes, habits, and the subjective features that pure demographics cannot capture. The psychographic profile, therefore, helps identify brand loyalty and brand interest so that groups of brands can be consolidated on one SNS lifestyle center web page for use by a particular group of consumers that will be attracted to similar lifestyle choices. The lifestyle center website (50) promotes and links the targeted consumer group to an anchor tenant website (300) as well. In one embodiment that does not limit the invention, the anchor tenant website may be a member page within the social networking system, or the anchor tenant website may be a separate website hosted elsewhere. The lifestyle center website (50) also links to additional tenants (400) whose brands are interesting to the consumers identified as having a particular psychographic profile and are interested in connecting within the social network service to the overall lifestyle center website within the social networking system. Overall, as shown at step (500), the computerized method of FIG. 2 connects member profiles on the social networking system server with the online lifestyle center (50) such that the anchor tenant within the lifestyle center website, additional tenants within the lifestyle center website, and members within the social networking system all connect based upon a pre-determined psychographic profile.

From the foregoing description of one embodiment of the invention, it will be apparent that many modifications may be made therein. It will be understood that this embodiment of the invention is an exemplification of the invention only and that the invention is not limited thereto.

1. A social networking system (SNS) implemented over a computerized network connecting a multitude of remote computers, the system comprising:
at least one SNS server hosting at least one lifestyle center website displaying digital content data related to at least one anchor tenant website also hosted on said SNS server;
at least one database stored on the SNS server and tracking member profiles corresponding to SNS users with accounts on the social networking service;
wherein said SNS server comprises a first non-transitory computer readable memory, said memory having computerized instructions programmed therein to connect a member profile with the lifestyle center website and granting the member profile access for bi-directional communication with the lifestyle center website; and
at least one remote computer operated by at least one SNS user having a member profile on the social networking service, wherein the remote computer comprises a second non-transitory computer readable memory storing communications software programmed to transmit communications data from the remote computer to the SNS server and to communicate with the lifestyle center website on the SNS server.

2. A social networking system (SNS) according to claim 1, wherein said lifestyle center website comprises at least one computerized link allowing members of the social networking service to access additional digital content data related to at least one additional tenant having a tenant website hosted on said SNS server and in electronic communication with said lifestyle center website.

3. A social networking system (SNS) according to claim 2, wherein said lifestyle center website comprises digital content data directed to an identified psychographic profile.

4. A social networking system (SNS) according to claim 3, wherein said digital content data comprises information related to brands for items purchased by said at least one individual having a member profile on the social networking service.

5. A social networking system (SNS) according to claim 3, wherein said anchor tenant and said additional tenants display respective digital content data directed to said identified psychographic profile.

6. A social networking system (SNS) according to claim 1, wherein said computerized instructions on said server implement member services for SNS users with member profiles, the member services including sending and receiving friend requests from other members of the social networking system.

7. A social networking system (SNS) according to claim 6, wherein the member services comprise customizing a member's access to the lifestyle center website.

8. A social networking system (SNS) according to claim 1, wherein said digital content data displayed by said lifestyle center website comprises brand advertising data.

9. A social networking system (SNS) according to claim 8, wherein said brand advertising data is directed to an identified psychographic profile.

10. A computerized method of implementing a social networking system (SNS) that electronically assimilates a database of social networking system (SNS) member profiles and associated brand websites on a social networking system (SNS) server connected by a data communications network to a plurality of remote computers, the method comprising:
identifying a respective psychographic profile to establish a lifestyle center website on the social networking system (SNS) server, wherein the lifestyle center website includes a first set of digital content data related to the psychographic profile;
displaying an anchor tenant website hosted on the SNS server and having a second set of digital content data related to the psychographic profile;
identifying social networking system member profiles that match the identified psychographic profile for the lifestyle center website; and
connecting within the social networking system the matching member profiles and the lifestyle center website.

11. A computerized method according to claim 10, further comprising connecting additional tenant websites to the lifestyle center website, wherein said additional tenant websites incorporate additional digital data content related to the psychographic profile of the lifestyle center website.

12. A computerized method according to claim 11, wherein the step of identifying a psychographic profile comprises gathering data from the anchor tenant.

13. A computerized method according to claim 12, wherein the step of gathering data from the anchor tenant comprises gathering sales data from the anchor tenant and establishing a consumer psychographic profile for the anchor tenant.

14. A computerized method according to claim 13, wherein the step of gathering sales data comprises gathering data selected from the group consisting of consumer credit card data, consumer zip code data, and consumer purchases data.

15. A computerized method according to claim 10, wherein the social networking system utilizes computer program instructions stored on the social networking system server to establish online relationships between the online lifestyle center and at least one member of the social networking system.

16. A computerized method according to claim 15, further comprising the step of adding additional tenant websites to the lifestyle center website for use by members connected to the lifestyle center website within the social networking system.

17. A computerized method according to claim 10, wherein the lifestyle center website connects the matching member profiles with a plurality of brands related to the identified psychographic profile.

18. A computerized method according to claim 17, wherein connecting to a plurality of brands comprises a member within the social networking system accessing the lifestyle center website, the anchor tenant website, and additional tenant websites.

19. A computerized method according to claim 10, further comprising the step of implementing member services on the social networking system, wherein the member services are selected from the group consisting of receiving and accepting connection requests within the social networking system, receiving recommendations from the lifestyle center website regarding brands available thereon, and joining groups of members on the social networking system.

20. A computerized method according to claim 10, further comprising the step of recruiting members to connect to a particular lifestyle center on the social networking service by promotional activities selected from the group consisting of in-store promotions, quick response (QR) codes, and online advertising.
